(19) United States
(12) Patent Application Publication
(10) Pub. No.: US 2014/0181539 A1
(43) Pub. Date: Jun. 26, 2014

(54) SYSTEM FOR ADAPTIVE -POWER CONSUMPTION DESIGN IN ULTRATHIN COMPUTING DEVICES

(71) Applicant: ADVANCED MICRO DEVICES, INC., Sunnyvale, CA (US)

(72) Inventor: I-Ming Lin, Taipei (TW)

(73) Assignee: ADVANCED MICRO DEVICES, INC., Sunnyvale, CA (US)

(21) Appl. No.: 13/725,791

(22) Filed: Dec. 21, 2012

(51) Int. Cl. G06F 1/26

(52) U.S. Cl. CPC G06F 1/26
USPC 713/300

(57) ABSTRACT

A system and method for adaptive power consumption in a computing device having a chassis forming an enclosure for a chamber. The computing device further includes, in the chamber, a heterogeneous processing unit that includes a CPU operatively coupled with a GPU and that generates thermal and performance information for the CPU and GPU, a memory, and a memory controller that connects the memory to the heterogeneous processing unit. A passive cooling subsystem and an active cooling subsystem cools off the chamber. A plurality of thermal sensors are positioned to monitor temperatures within the chamber. A thermal detection and control unit receives thermal and performance information from the heterogeneous processing unit and the plurality of thermal sensors and responsively adjusts overall power consumption of the heterogeneous processing unit, the memory controller, the memory and the active cooling subsystem to maintain performance of the heterogeneous processing unit while minimizing thermal heating.

### TECHNICAL FIELD

The present invention relates to adaptive system-power consumption applications and more specifically to improving adaptive system-power consumption in ultrathin or tablet computing devices.

### BACKGROUND

With the advent of internet computing devices that simplify remote access to information and applications, the need has arisen for portable computing devices such as ultrathin notebooks, tablet PCs and ultra-mobile PCs that are designed with emphasis on the user interface while minimizing the impact on the size and shape of the object of other components, such as the memory, battery and processing components. Often, the compactness of the operating space for the various components can result in an increase in the thermal operating temperature that adversely may affect performance. Additionally, the demands on maximizing battery life while attempting to minimize performance can also affect the performance of the processor.

In the past, attempts to regulate power consumption in relation to operating temperature, battery life while maximizing performance had been approached independently by the manufacturer of the devices and by the manufacturer of the processing components. These independent attempts to solve a collective problem were often not well coordinated and lacked the kind of integrated feedback and control that could ensure processor performance was at optimal power demand. Furthermore, in order to ensure adequate operating temperatures, minimal spatial displacement or minimal open space in the device is presently suggested for higher speed computing devices that are simply too large for use in thin client and tablet type computing devices. Similarly, thermal design power (TDP) minimal thresholds are provided minimal wattage for operation of the computing devices. Thus, the need exists for a way to optimize power demand while minimizing thermal operating temperature without sacrificing performance in an integrated and compact environment.

### SUMMARY OF EMBODIMENTS

Embodiments of the present invention include a system and method for adaptive power consumption in a computing device having a chassis forming an enclosure for a chamber. The computing device further includes, in the chamber, a heterogeneous processing unit that includes a CPU operatively coupled with a GPU and that generates thermal and performance information for the CPU and GPU, a memory, and a memory controller that connects the memory to the heterogeneous processing unit. A passive cooling subsystem is included that draws heat from the heterogeneous processing unit. An active cooling subsystem cools off the chamber. A plurality of thermal sensors is positioned to monitor temperatures within the chamber relating to the heterogeneous processing unit, the passive cooling subsystem and the active cooling subsystem. A thermal detection and control unit receives thermal and performance information from the heterogeneous processing unit and the plurality of thermal sensors and responsively adjusts overall power consumption of the heterogeneous processing unit, the memory controller, the memory and the active cooling subsystem to maintain performance of the heterogeneous processing unit while minimizing thermal heating.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a block diagram of a computing system according to embodiments of the present invention;

FIG. 2 is a block diagram of a computing system having system power management control according to embodiments of the present invention;

FIG. 3 is a block diagram of a computing device having thermal sensors according to embodiments of the present invention; and

FIG. 4 is a chart of functional inputs and tasks performed by system power management control in a computing device according to embodiments of the present invention.

### DETAILED DESCRIPTION OF THE PREFERRED EMBODIMENTS

Embodiments of the invention as described herein provide a solution to the problems of conventional methods. In the following description, various examples are given for illustration, but none are intended to be limiting. Embodiments include implementing a computing system using a novel hardware temperature control system.

In the following description, numerous specific details are introduced to provide a thorough understanding of, and enabling description for, embodiments of the implementing temperature control. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

Computers and other such data processing devices have at least one control processor that is generally known as a control processing unit (CPU). Such computers and processing devices operate in environments which can typically have memory, storage, input devices and output devices. Such computers and processing devices can also have other processors such as graphics processing units (GPU) that are used for specialized processing of various types and may be located with the processing devices or externally, such as, included the output device. For example, GPUs are designed to be particularly suited for graphics processing operations. GPUs generally comprise multiple processing elements that are ideally suited for executing the same instruction on parallel data streams, such as in data-parallel processing. In general, a CPU functions as the host or controlling processor and hands-off specialized functions such as graphics processing to other processors such as GPUs.

With the availability of multi-core CPUs where each CPU has multiple processing cores, substantial processing capabilities that can also be used for specialized functions are available in CPUs. One or more of the computation cores of multi-core CPUs or GPUs can be part of the same die (e.g., AMD Fusion™) or in different dies (e.g., Intel Xeon™ with NVIDIA GPU). Recently, hybrid cores having characteristics of both CPU and GPU (e.g., CellSPE™, Intel Larrabee™) have been generally proposed for General Purpose GPU (GPGPU) style computing. The GPGPU style of computing advocates using the CPU to primarily execute control code and to offload performance critical data-parallel code to the GPU. The GPU is primarily used as an accelerator. The combination of multi-core CPUs and GPGPU computing model encompasses both CPU cores and GPU cores as accelerator targets. Many of the multi-core CPU cores have performance that is comparable to GPUs in many areas. For example, the floating point operations per second (FLOPS) of many CPU cores are now comparable to that of some GPU cores.

Embodiments of the present invention may yield substantial advantages by enabling the use of the same or similar code based on CPU and GPU processors and also by facilitating the debugging of such code bases. While the embodiments of the present invention are described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention may be used in any computer system, computing device, entertainment system, media system, game systems, communication device, personal digital assistant, or any system using one or more processors. The embodiments of the present invention are particularly useful where the system comprises a heterogeneous computing system. A “heterogeneous computing system,” as the term is used herein, is a computing system in which multiple kinds of processors are available.

Embodiments of the present invention enable the same code base to be executed on different processors, such as GPUs and CPUs. Embodiments of the present invention, for example, can be particularly advantageous in processing systems having multi-core CPUs, and/or GPUs, because code developed for one type of processor can be deployed on another type of processor with little or no additional effort. For example, code developed for execution on a GPU, also known as GPU-kernels, can be deployed to be executed on a CPU, using embodiments of the present invention.

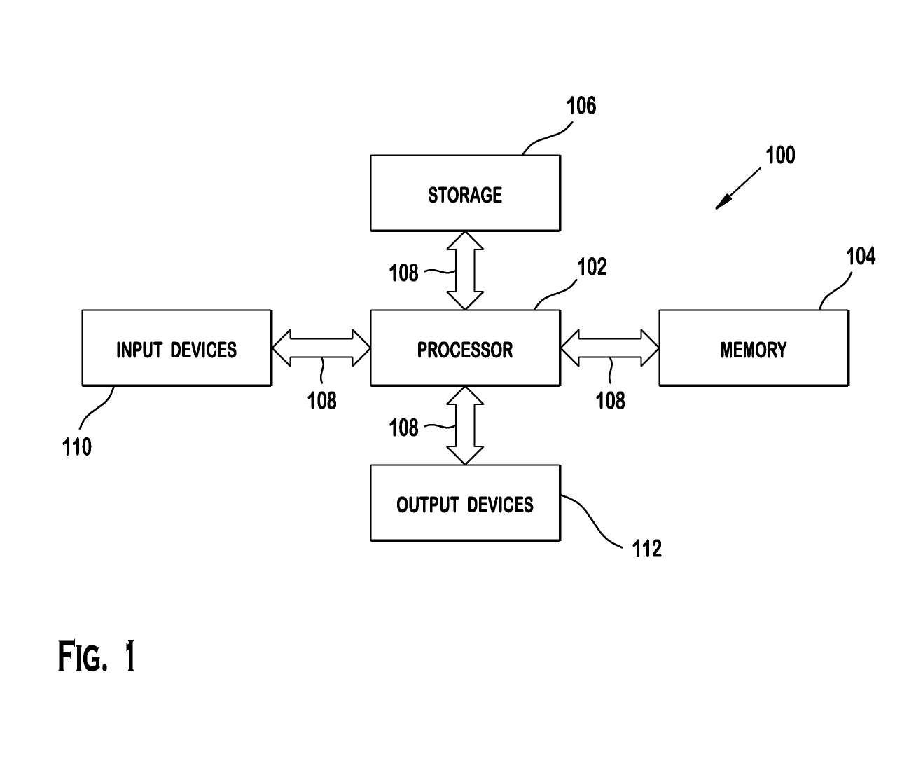

An example heterogeneous computing system 100, according to an embodiment of the present invention, is shown in FIG. 1. Heterogeneous computing system 100 can include one or more processing units, such as processor 102. Heterogeneous computing system 100 can also include at least one system memory 104, at least one persistent storage device 106, at least one system bus 108, at least one input device 110 and output device 112.

A processing unit of the type suitable for heterogeneous computing is the accelerated processing units (APUs) sold under the brand name Fusion by AMD of San Jose, Calif., according to embodiments of the present invention. A heterogeneous processing unit includes one or more CPUs and one or more GPUs, such as a wide single instruction, multiple data (SIMD) processor and unified video decoder perform functions previously handled by a discrete GPU. It will be understood that when referring to the GPU structure and function, such functions are carried out by the SIMD. Heterogeneous processing units can also include at least one memory controller for accessing system memory and that also provides memory shared between the GPU and CPU and a platform interface for handling communication with input and output devices through, for example, a controller hub.

A wide single instruction, multiple data (SIMD) processor for carrying out graphics processing instructions may be included to provide a heterogenous GPU capability in accordance with the embodiments of the present invention or a discrete GPU may be included separated from the CPU to implement the embodiments of the present invention; however, as will be understood by those skilled in the art, additional latency may be experienced in an implementation of embodiments of the present invention using a discrete GPU.

Advantageously, CPU architecture of the types described above are well suited for implementation using adaptive system-power consumption in embodiments of the present invention. In fact, embodiments of the present invention allow for the incorporation of existing and developing CPU architectures which previously had TDP values too large to operate efficiently in ultrathin or compact computing device designs.

In current conventional computing device designs, the selection of the processing components in relation to the design of the computing device is determined by the TDP (Thermal Design Power) value assigned by the manufacturer to the processing components. For example, if a CPU has a TDP that is 35 W, then the computing device manufacturer would need to design a housing sized and equipped with thermal cooling features to accommodate a CPU having 35 watts of TDP for normal operation; otherwise, weak or insufficient thermal cooling solutions in the design would cause the system to shutdown due to CPU overheating.

One way to improve processing component selection is through the introduction of configurable TDP in which a processing component is constructed to operate at a low wattage TDP, but can jump to mid wattage TDP until thermal allowances push it back down, such as, from 17 W to 32 W.

Advantageously, embodiments of the present invention can incorporate all of the above processing components when operated cooperatively with a system power management control circuit that dynamically senses the thermal conditions of the computing device and the processing components to adjust the thermal cooling features and TDP of the processing components according to the thermal conditions. The result is that processing components no longer have a fixed TDP requirement and can be used in more compact housings for smaller computing devices.

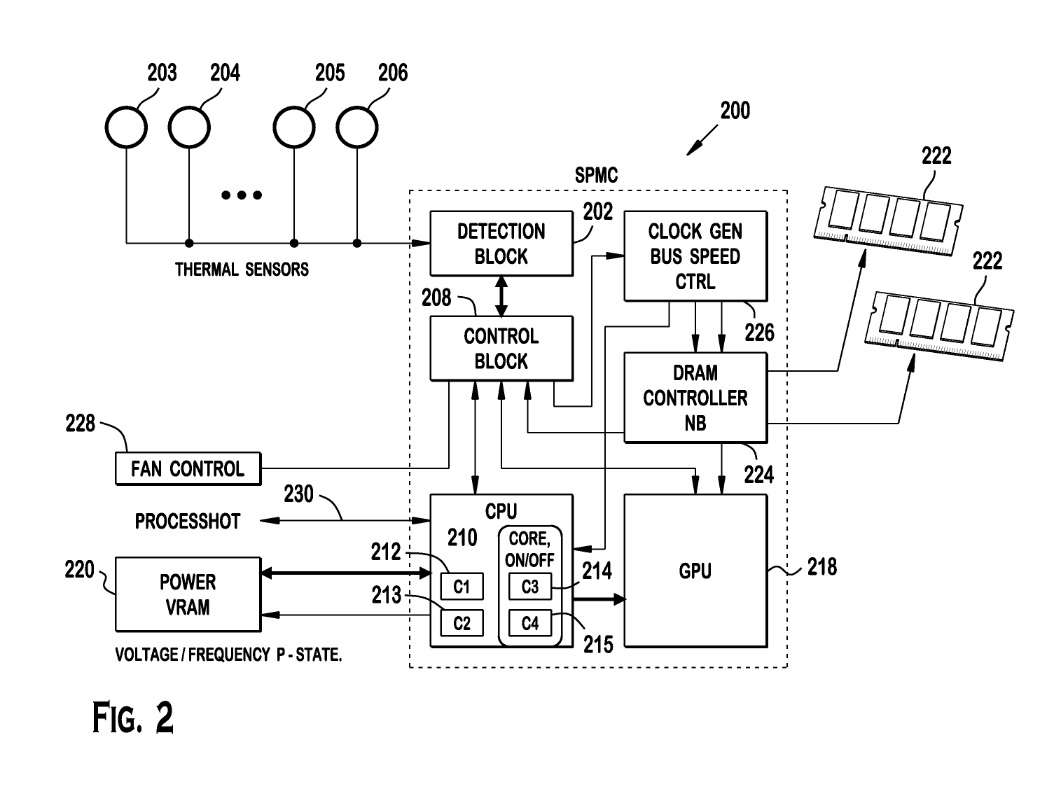

With reference to FIG. 2, a System Power Management Control (SPMC) circuit 200 includes a detection block 202 in signal communication with thermal sensors 203-206 located throughout a computing device that provide relevant thermal information relevant to the operation of the processing components. The detection block is responsive to a control block 208 to provide thermal information. Thermal detection is a desirable feature in embodiments of the invention. The detection block provides feedback to the control block to let the computing device components operate in thermal balance. In embodiments of the present invention, the detection block is further able to monitor the limits on the APU/CPU TDP in accordance with the overall thermal specification of the computing device such that regardless of the applications that are running the APU/CPU TDP would not go higher than the overheat threshold of the computing device to trigger thermal shutdown of the computing device as a last resort safety feature. There is a total detection switcher and arbitrator inside the detection block accessible through the APU/CPU that provides the Thermal sensor detector summary and commands.

The control block 208 interacts with a heterogeneous processing unit represented herein by a quad core CPU 210 having cores 212-215, where cores 214 and 215 can be selectively disabled, and GPU 218 cooperating with VRAM 220 and DRAM 222 via a DRAM controller 224 and clock generator 226 for controlling the processor speed and BUS speed. The control block 208 directly interacts with the CPU 210, GPU 218, DRAM controller 224 and clock generator 226 to obtain temperature and performance feedback via the detection block 202 as well as to control clock speed and performance based upon the operating temperature reading reported by the sensors 203-206, the CPU 210, the GPU 218 and the DRAM controller 224. The control block 208 also directly connects to the fan control 228. The heterogeneous processing unit includes leads connected to the Power Video Random Access Memory (VRAM) 220. A “process hot” lead 230 extends from the CPU and provides a hi/low status as to when the CPU performance is reduced due to excessive heat. This lead 230 can either by changed by the CPU or by other components input devices 110 and output devices 112 included in the computing device to identify that the computing device is running hot.

In embodiments of the present invention, the detection block 202 is further able to monitor the limits on the APU/CPU TDP in accordance with the overall thermal specification of the computing device such that regardless of the applications that are running the APU/CPU TDP would not go higher than the overheat threshold of the computing device to trigger thermal shutdown of the computing device as a last resort safety feature. There is a total detection switcher and arbitrator inside the detection block accessible through the APU/CPU that provides the thermal sensor detector summary and commands.

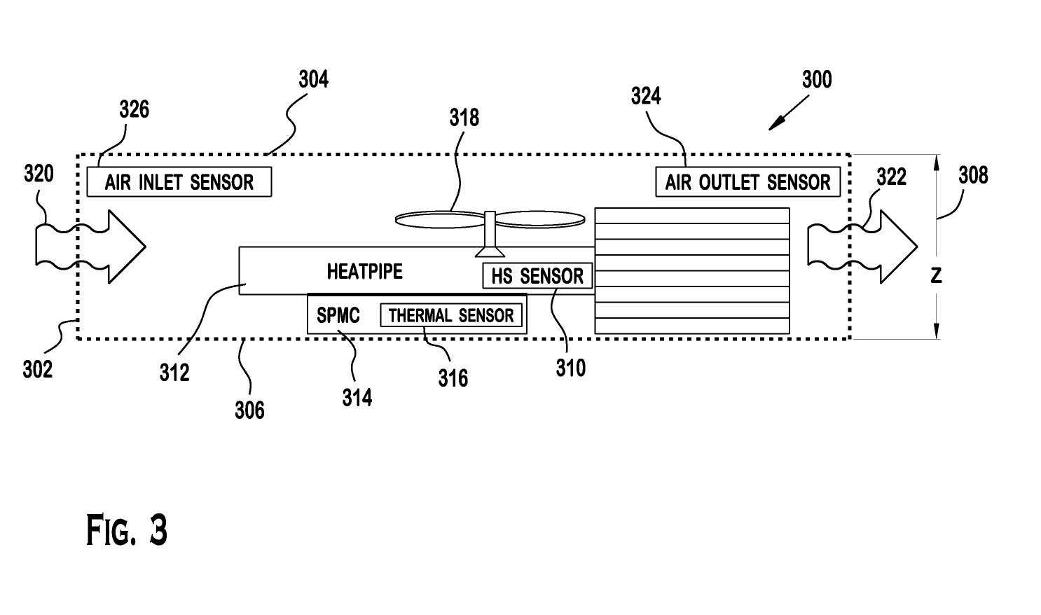

With reference to FIG. 3, embodiments of the invention as described include a computing device 300 having a chassis 302 including two generally planar surfaces 304 and 306 connected about the perimeter to define a chamber having a Z-height represented by line 308. Thermal sensors include a heat sink sensor 310 located on a heat sink or heat pipe 312. A SPMC 314 is included connected to the heat sink 312 and having a thermal sensor 316. A fan 318 draws air through the chassis 302 between an air inlet 320 and air outlet 322. Thermal sensors further include an outlet thermal sensor 324 at the air outlet 322 and an inlet thermal sensor 326 at the air inlet 320. A long life battery (not shown) may be included to further compensate for power consumption of the cooling fan and for handling the higher performance demands of the CPU at lower temperatures.

It will be appreciated with embodiments using this configuration (FIG. 2) that the control block 208 controls CPU 210 power consumption from highest P-state to lowest by CPU loading through HTC (hardware thermal control), and GPU 218 power consumption by NBP-state changing from highest to lowest taking into consideration graphic loading as well. P-states are operational performance states (states in which the processor is executing instructions, running software) characterized by a unique frequency and voltage and NBP-states are operational performance states of the Northbridge. The control block 208 handles both of these power consumption considerations together. Additionally, the control block 208 takes into consideration the computing device housing and component parameters, for example, the Z-height of the system chassis is known to determine the amount of ambient air flow and sensors to monitor thermal conditions at the air inlet, air outlet, at the CPU and on the heat sink to adjust FAN speed and system speed/power consumption control. Therefore, the control block can work dynamically with the thermal controls and power consumption control provided by the processing components and integrates with other chassis components to work with any processing components regardless of the manufacturer or the processing component or the computing device. Embodiments of the present invention are generally represented by the power consumption (Watts) considerations represented by:

Operating Watts=Z-height+Heat Sink+Fan Speed+HTC+System Cooling,

where power consumption is influenced by the Z-height of the computing device, passive hardware cooling techniques such as heat sinks and placement of system components to distribute heat, active hardware cooling such as cooling fan speed control, hardware thermal control (HTC) and other system cooling techniques as will be more fully disclosed below.

In conventional computing device designs, planning for the thermal considerations typically required consideration for active and passive hardware cooling techniques individually tailored for each chassis in which HTC and system cooling were pre-defined “as is” by the processing component manufacturer. Embodiments of the present invention allow for greater flexibility of these considerations by recognizing that regardless of the ultimate shape of the computing device, each computing device design has an amount of ambient airflow as represented by the Z-height of air space in the computing device. By using a Z-height as a selection criteria for determining the thermal management features of the SPMC circuit 200, computing device designers have greater control and flexibility in choosing processing components with higher processing capabilities and more closely tailored to the overall computing device chassis design. By way of example and not by limitation, embodiments of the present invention configured to conform with a Z-height range include the following features:

| | 10 mm < Z- | 21 mm < Z- |
|---|---|---|
| Z-height < 10 mm | height < 21 mm | height < 30 mm |
| Heavy Thermal Control: | Intermediate Thermal | Minimal Thermal |
| HTC using P-State | Control: | Control: |
| Limits | HTC | HTC |
| Cooling Technology | Thermal Throttling with | Highest GPU |
| Long Life Battery | power tuning | performance |
| HW/SW/BIOS optimal | and PSPP | |
| thermal control | Cooling | |
| | Technology | |

From the table above it may be understood that as the Z-height is increased the number of features to decrease the thermal operating temperature are reduced. Thereby reducing the manufacturing cost of the computing device while ultimately increasing the overall size of the computing device chassis.

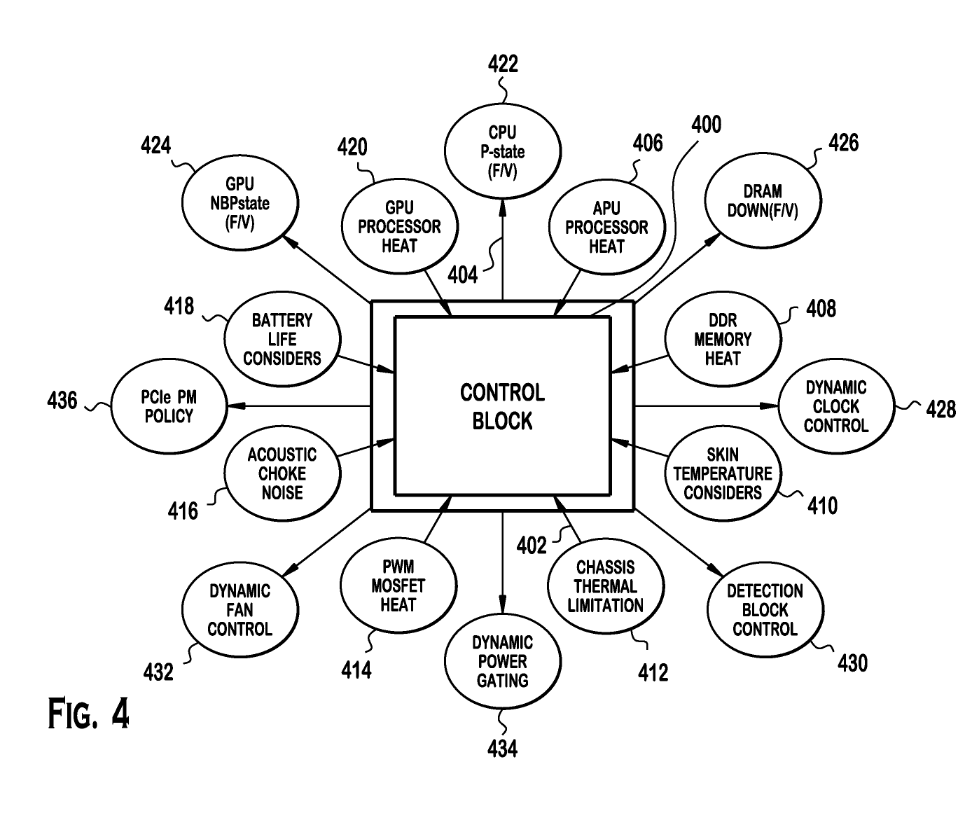

By way of example, a chassis design with a Z-height of less than 10 mm, the cooling technology includes air inlets and air outlets positioned at opposite ends of the chassis to optimize airflow across the heat sink or heat pipe. The high heat elements are positioned to traverse the air flow provided by the air inlet and outlet. A cooling fan is included that includes hi and low settings such that the fan is always on. With reference to FIG. 4, the control block 400 functionally is equipped with design consideration parameters represented by incoming arrows 402 that affect the function of the control block heat control engines as represented by out going arrows 404 within the SPMC 200 (FIG. 2). The control block 400 (FIG. 4) is preferably an application specific integrated circuit (ASIC) that operates in cooperation with the GPU and CPU to monitor and control the thermal conditions of the computing device. As used herein the use of the “engine” is intended to mean a dedicated system component configured either as hardware or hardware operating under the control of software to perform a specific task. The design consideration parameters are stored into the control block at the time of manufacture and may be updated as needed in subsequent software updates. The design parameter considerations are not all required, such that embodiments of the present invention may include one or more of these design parameter considerations. These include the APU/CPU heat thresholds 406 relating to the P-State, DDR Memory heat thresholds 408 relating to frequency and bandwidth, skin temperature considerations 410 as to how hot the chassis should feel to the user. Similarly, a chassis thermal limitation 412 provides the heat threshold at which the chassis or other components within the chassis are affected by the temperature. Pulse Width Modulation (PWM) MOSFET heat 414 generated by varying the speed of the cooling fan. Acoustic chock noise 416 relates to a low frequency threshold at which components in the power supply may begin to generate an undesirable noise. Battery life considerations 418 relate to a number of factors including, but not limited to the heat generated by the battery, the affect of active cooling measures such the cooling fan on the battery life and the power consumption demands of the application used and the processing features required. Finally, GPU heat parameters 420 relating to the NBP-state.

Embodiments of the present invention may include one or more of the control block engines that use the appropriate one or more design consideration parameters to actively react to temperature changes provided by the detection block. A CPU/APU control engine 422 enables the “Process Hot” lead 230 (FIG. 2) to control CPU P-state at a level appropriate for the temperature and application used. It will be understood that the APU/CPU can typically include, but are not limited to, 4 to 8 P-states, where every P-state has different frequency/voltage defined. When thermal conditions warrant P-states having a low frequency and voltage setting, the APU/CPU control engine can automatically enter DC mode (battery mode) even when the system still has AC Adaptor inserted and connected to power, it will let the OS (operating system) assume the computing device is working in DC mode, so most of power management features in the OS, software applications and drivers will enable power saving mode.

In embodiments of the present invention incorporating a quad-core processor, the APU/CPU control engine 422 (FIG. 4) for P-states having a low frequency and voltage setting automatically disables 2 cores 214 and 215 (FIG. 2) in the quad core processor 210 without requiring a system reboot. When the system is maintained to work in hot operating environments, then it can easily work well in dual core mode using cores 212 and 213 continuing to service all running software application and to accommodate the thermal conditions reported from the detection block.

A GPU control engine 424 (FIG. 4) also reacts to the “Process Hot” lead 230 (FIG. 2) to limit the GPU at an appropriate NBP-state conforming to the P-state of the APU/CPU. The GPU control engine also enables/disables the BAPM (bi-directional application power management function) between the CPU and GPU by automatic control in response to the detection block. The GPU control engine 424 (FIG. 4) of the control block limits and/or controls the GPU NBP-state not only in cooperation with the APU/CPU P-state, but in a manner that it would not affect current VGA driver behavior, where conventional systems use the VGA driver to control the GPU NBP-state. When thermal conditions warrant P-states having a low frequency and voltage setting, the GPU control engine 424 can automatically disable the GPU SIMD decoder or pipeline internally to avoid a thermal shutdown. It will further be appreciated that depending upon the type of heterogeneous processing unit selected, the operation of the GPU and CPU can be so closely integrated that embodiments of the present invention include the function of the GPU control engine incorporated into the APU/CPU control engine 422.

A DRAM control engine 426 automatically enables or disables Memory DIMM support from 2channel to 1channel via the DRAM controller 224 (FIG. 2). The DRAM control engine 426 can automatically raise or lower DRAM speed according conventionally accepted frequency states including, but not limited to, from 1866 Mhz to 1333 Mhz to 1066 Mhz, and 533 Mhz.

A system clock control engine 428 (FIG. 4) controls the system clock 226 (FIG. 2) throttling to ensure the computing device components and bus frequencies are calibrated to the P-state of the APU/CPU.

A detection block control engine 430 (FIG. 4) for interacting with the detection block 202 (FIG. 2).

A fan control engine 432 (FIG. 4) automatically increases or decreases FAN speed to change active cooling and allow for the APU/CPU to operate with increased or decreased performance, respectively.

A power gating control engine 434 automatically slows down system performance by enabling CLK (clock) stop gating in which gates only consume power and switch when the gate clock advances.

A bus control engine 436 can automatically insert wait state or similar command at PCIe bus, USB3.0 bus, PCIe 16lanes GPE bus, where wait states can be used to reduce the energy consumption of a processor, by allowing the main processor clock to either slow down or temporarily pause during the wait state if the CPU has no other work to do. Rather than spinning uselessly in a tight loop waiting for data, sporadically reducing the clock speed in this manner helps to keep the processor core cool and to extend battery life in portable computing devices.

It will be appreciated by those skilled in the art that where heavy thermal control is used such embodiments of the present invention would use all or most the control block engines discussed above.

In embodiments where intermediate thermal control is used such as where the Z-height of the computing device chassis allows ambient air in the range of between 10 mm and 21 mm, a subset of the control block control engines can be used. Embodiments of the present invention utilizing a sub set of the control block engines would implement a power tuning or a PSPP (Platform Sizing and Performance Program) benchmark suite to determine the optimal engines to incorporate in the design.

In embodiments where intermediate thermal control is used such as where the Z-height of the computing device chassis allows ambient air in the range of between 10 mm and 21 mm, a subset of the control block control engines can be used. Embodiments of the present invention utilizing a sub set of the control block engines would implement a power tuning or a PSPP (Platform Sizing and Performance Program) benchmark suite to determine the optimal engines to incorporate in the design.

Embodiments of the present invention incorporating minimal thermal control, where maximum processing performance can be utilized, the control block can manage thermal control through HTC alone using the APU/CPU control engine and GPU control engine. Other control block engines may also be utilized such as the fan control engine, but not necessarily to minimize thermal heating, to maintain thermal control when high processor performance is demanded.

It will be appreciated by those skilled in the art, that the implementation of the control block and detection block allows for the processor to not only operate at different discrete power states, but across a range of power states. By way of example and not by limitation, an APU design in the form of an AMD A10-4600M APU with a Radeon™ HD Graphics 1.6 GHz having power consumption rating of 35 W TDP was incorporated in a SPMC utilizing heavy thermal control by the control block gross power consumption of the APU ranged from 2.322-5.957 W when system was running a 3DMark06, which is a DirectX 9 graphics card benchmark for testing a computing device's gaming performance. Thus is will be appreciated that the power savings derived from the control block thermal controls can be substantial.

Advantageously, it will be appreciated that embodiments of this invention allow for the incorporation of greater processing power that can be included when considering a new tablet or ultra-book design. Moreover, embodiments of this invention can conform thermal design requirements and without sacrifice higher performance.

In other embodiments of the invention, the hardware described above can be implemented using a processor executing instruction from a non-transitory storage medium. Those skilled in the art can appreciate that the instructions are created using a hardware description language (HDL) that is a code for describing a circuit. An exemplary use of HDLs is the simulation of designs before the designer must commit to fabrication. The two most popular HDLs are VHSIC Hardware Description Language (VHDL) and VERILOG. VHDL was developed by the U.S. Department of Defense and is an open standard. VERILOG, also called Open VERILOG International (OVI), is an industry standard developed by a private entity, and is now an open standard referred to as IEEE Standard 1364. A file written in VERILOG code that describes a Joint Test Access Group (JTAG) compliant device is called a VERILOG netlist. VHDL is an HDL defined by IEEE standard 1076.1. Boundary Scan Description Language (BSDL) is a subset of VHDL, and provides a standard machine- and human readable data format for describing how an IEEE Std 1149.1 boundary-scan architecture is implemented and operates in a device. Any HDL of the types described can be used to create instructions representative of the hardware description.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system for adaptive power consumption comprising:
a computing device including:
a chassis forming an enclosure for a chamber;
the computing device further includes in the chamber:
a heterogeneous processing unit that includes a CPU operatively coupled with a GPU and that generates thermal and performance information for the CPU and GPU;
a memory;
a memory controller that connects the memory to the heterogeneous processing unit;
a passive cooling subsystem that draws heat from the heterogeneous processing unit;
an active cooling subsystem that cools off the chamber;
a plurality of thermal sensors positioned to monitor temperatures within the chamber relating to the heterogeneous processing unit; the passive cooling subsystem and the active cooling subsystem; and
a thermal detection and control unit that receives thermal and performance information from the heterogeneous processing unit and the plurality of thermal sensors and responsively adjusts overall power consumption of the heterogeneous processing unit, the memory controller, the memory and the active cooling subsystem to maintain performance of the heterogeneous processing unit while minimizing thermal heating.

2. The system of claim 1 wherein:
the CPU and GPU each including at least two P-states having a predetermined frequency and voltage and bi-directional application power management that adjusts the power allocated between the GPU and CPU depending upon the demand; and
the thermal detection and control unit includes CPU control engine that, in response to the thermal and performance information, changes between the at least two P-states of the CPU and GPU and controls bi-directional application power management.

3. The system of claim 1 wherein:
the CPU and GPU each including at least two P-states having a predetermined frequency and voltage;
the thermal detection and control unit includes CPU control engine that, in response to the thermal and performance information, changes between the at least two P-states of the CPU; and
the thermal detection and control unit includes GPU control engine that, in response to the thermal and performance information, changes between the at least two P-states of the GPU.

4. The system of claim 2 wherein:
the CPU is a quad-core processing unit having quad-core and dual core operating modes;
the CPU control engine responsive to the thermal and performance information to change between the quad core and dual core operating modes.

5. The system of claim 1 wherein:
the thermal detection and control unit includes:
a memory control engine that, in response to the thermal and performance information, changes the memory controller speed by changing the operating frequency.

6. The system of claim 1 further including:
a system clock;
wherein the thermal detection and control unit includes a system clock control engine that, in response to the thermal and performance information, changes the system clock speed.

7. The system of claim 1 wherein:
the chassis includes two similarly sized generally planar surfaces joined in spaced apart relation about an outer perimeter to form the enclosure and chamber;
the computing device further includes:
input devices; and
output devices;
wherein the passive cooling subsystem includes apertures formed in the enclosure to permit air flow into and out of the chamber and a heat sink connected to the heterogeneous processing unit;
wherein the active cooling subsystem includes a fan to force airflow into and out of the chamber;
wherein thermal sensors are located proximate to the apertures, the heat sink and the heterogeneous processing unit to collect thermal information; and
the thermal detection and control unit includes a plurality of control engines that, in response to the thermal and performance information, control the fan, control the operating speed and voltage settings in the heterogeneous processing unit and control the speed and bandwidth between the memory and memory controller.

8. The system of claim 7 wherein:
the heterogeneous processing unit is configured under the control of an operating system and software applications to perform specific functions;
the heterogeneous processing unit notifies the operating system and software whether the computing device is operating on a battery or a continuous power supply and operating system includes modes that operate in a full power mode and a battery saving power mode;
wherein the thermal detection and control unit, in response to the thermal and performance information of a high heat condition, enables the battery saving power mode regardless of the power supply connected to the computing device.

9. A method for adaptive power consumption, in a computing device including a chassis forming an enclosure forming a chamber, the computing device further includes in the chamber a heterogeneous processing unit that includes a CPU operatively coupled with a GPU and that generates thermal and performance information for the CPU and GPU, a memory, a memory controller that connects the memory to the heterogeneous processing unit, a passive cooling subsystem that draws heat from the heterogeneous processing unit, an active cooling subsystem that cools off the chamber, a plurality of thermal sensors positioned to monitor temperatures within the chamber relating to the heterogeneous processing unit, the passive cooling subsystem and the active cooling subsystem, comprising:
receiving thermal and performance information from the heterogeneous processing unit and the plurality of thermal sensors; and
responsively adjusting overall power consumption of the heterogeneous processing unit, the memory controller, the memory and the active cooling subsystem to maintain performance of the heterogeneous processing unit while minimizing thermal heating.

10. The method of claim 9 including:
wherein the CPU and GPU each including at least two P-states having a predetermined frequency and voltage and bi-directional application power management that adjusts the power allocated between the GPU and CPU depending upon the demand;
providing a CPU control engine that, in response to the thermal and performance information; and
responsively adjusting overall power consumption includes changing between the at least two P-states of the CPU and GPU and controlling bi-directional application power management.

11. The method of claim 9 including:
wherein the CPU and GPU each including at least two P-states having a predetermined frequency and voltage and bi-directional application power management that adjusts the power allocated between the GPU and CPU depending upon the demand; and
providing a CPU control engine that, in response to the thermal and performance information;
providing a GPU control engine that, in response to the thermal and performance information; and
responsively adjusting overall power consumption includes changing between the at least two P-states of the CPU and GPU and controlling bi-directional application power management.

12. The method of claim 10 including:
wherein the CPU is a quad-core processing unit having quad-core and dual core operating modes;
responsively adjusting overall power consumption includes changing between the quad core and dual core operating modes.

13. The method of claim 9 including:
providing a memory control engine responsive to the thermal and performance information; and
responsively adjusting overall power consumption includes changing the memory controller speed by changing the operating frequency.

14. The method of claim 9 including:
wherein the heterogeneous processing unit further includes a system clock;
providing a system clock control engine responsive to the thermal and performance information; and
responsively adjusting overall power consumption includes changing the system clock speed.

15. The method of claim 9 including:
wherein the chassis includes two similarly sized generally planar surfaces joined in spaced apart relation about an outer perimeter to form the enclosure and chamber;
the computing device further includes:
input devices; and
output devices;
wherein the passive cooling subsystem includes apertures formed in the enclosure to permit air flow into and out of the chamber and a heat sink connected to the heterogeneous processing unit;
wherein the active cooling subsystem includes a fan to force airflow into and out of the chamber;
wherein thermal sensors are located proximate to the apertures, the heat sink and the heterogeneous processing unit to collect thermal information; and
providing a plurality of control engines responsive to the thermal and performance information; and
responsively adjusting overall power consumption includes:
controlling the fan;
controlling the operating speed and voltage settings in the heterogeneous processing unit; and
controlling the speed and bandwidth between the memory and memory controller.

16. The method of claim 15 wherein:
the heterogeneous processing unit is configured under the control of an operating system and software applications to perform specific functions;
the heterogeneous processing unit notifies the operating system and software whether the computing device is operating on a battery or a continuous power supply and operating system includes modes that operate in a full power mode and a battery saving power mode;
responsively adjusting overall power consumption includes enabling the battery saving power mode regardless of the power supply connected to the computing device.

17. A computer readable non-transitory medium including instructions which when executed in a processing system cause the system to provide adaptive power consumption, in a computing device including a chassis forming an enclosure forming a chamber, the computing device further includes in the chamber a heterogeneous processing unit that includes a CPU operatively coupled with a GPU and that generates thermal and performance information for the CPU and GPU, a memory, a memory controller that connects the memory to the at least one heterogeneous processing unit, a passive cooling subsystem that draws heat from the heterogeneous processing unit, an active cooling subsystem that cools off the chamber, a plurality of thermal sensors positioned to monitor temperatures within the chamber relating to the heterogeneous processing unit, the passive cooling subsystem and the active cooling subsystem, comprising:
receiving thermal and performance information from the heterogeneous processing unit and the plurality of thermal sensors; and
responsively adjusting overall power consumption of the heterogeneous processing unit, the memory controller, the memory and the active cooling subsystem to maintain performance of the heterogeneous processing unit while minimizing thermal heating.

18. The computer readable non-transitory medium of claim 17, wherein the at least one heterogeneous processing unit includes an APU having a CPU and GPU each having at least two P-states having a predetermined frequency and voltage and bi-directional application power management that adjusts the power allocated between the GPU and CPU depending upon the demand, including instructions wherein:
responsively adjusting overall power consumption includes changing between the at least two P-states of the CPU and GPU and controlling bi-directional application power management.

19. The computer readable non-transitory medium of claim 17, wherein the at least one heterogeneous processing unit includes a CPU having at least two P-states having a predetermined frequency and voltage, including instructions wherein adjusting power consumption of the at least one heterogeneous processing unit includes changing between the at least two P-states of the CPU.

20. The computer readable non-transitory medium of claim 19, wherein the CPU is a quad-core processing unit having quad-core and dual core operating modes, including instructions wherein adjusting power consumption of the at least one heterogeneous processing unit includes changing between the quad core and dual core operating modes.
